(19) United States
(12) Patent Application Publication
(10) Pub. No.: US 2025/0390490 A1
(43) Pub. Date: Dec. 25, 2025

(54) NATURAL LANGUAGE QUERY FILTERING

(71) Applicant: ADOBE INC., San Jose, CA (US)

(72) Inventors: Yeuk-Yin Chan, San Jose, CA (US); Tung Mai, San Jose, CA (US); Saurabh Tripathy, Hayward, CA (US); Akash Vivek Maharaj, Palo Alto, CA (US); Eunyee Koh, Sunnyvale, CA (US); Saayan Mitra, San Jose, CA (US); Aleksander Pejcic, Lafayette, CA (US)

(21) Appl. No.: 18/747,630

(22) Filed: Jun. 19, 2024

(51) Int. Cl. G06F 16/2452; G06F 16/242; G06F 40/284

(52) U.S. Cl. CPC G06F 16/24522; G06F 16/243

(57) ABSTRACT

A method, apparatus, non-transitory computer readable medium, and system for data processing include receiving a natural language query including a request for data from a database, generating a natural language query embedding representing the natural language query in a vector space, and determining a validity of the natural language query by comparing the natural language query embedding to a valid query embedding in the vector space. Some embodiments include converting the natural language query into a structured query based on the validity of the natural language query and retrieving the data from the database using the structured query.

### BACKGROUND

Databases are queried using structured queries written in query languages that express database interactions unambiguously. However, not all database users are familiar with the query languages. Machine learning models (e.g., large language models) can be used to translate natural language queries into structured queries written in an appropriate query language, but not all natural language statements can be converted into a valid database query in a structured format. Furthermore, operating a machine learning model such as a large language model can be computationally intensive and expensive.

### SUMMARY

Systems and methods are described for filtering natural language queries by determining whether the queries can be converted into a structured query for data retrieval. In one example, a natural language query is encoded to obtain a query embedding, and the query embedding is compared to one or more valid embeddings. If the query embedding is sufficiently close to the one or more valid embeddings, a machine learning model converts the query to a structured query for data retrieval. If the query embedding is not close to the valid embeddings, a warning is returned and the machine learning model is not used to convert the natural language query. The valid embeddings may be generated algorithmically by generating a variety of valid queries and encoding them in the query embedding space.

Conventional database management systems (DBMS) evaluate the validity of structured queries in a query language. The use of computationally intensive machine learning models to convert natural language queries into structured queries can be helpful in instances where the natural language input can be fit into a structure recognizable by the DBMS. However, when the natural language input cannot be fit into a recognizable structured query, the use of a machine learning model to convert the query to a structured form wastes the extensive computational resources of the machine learning model. That is, the computation resources of the machine learning model are used even when the resulting structured queries are invalid.

Therefore, embodiments of the disclosure improve on conventional DBMS technology by enabling efficient filtering of natural language queries before the conversion of these queries into a structured query language. This enables a DBMS to avoid the use of computationally expensive machine learning models when the output is likely to be invalid.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 shows an example of a data processing system that employs a filtering method according to aspects of the present disclosure.

FIG. 2 shows an example of a method for retrieving data from a database using a filtering method according to aspects of the present disclosure.

FIG. 3 shows an example of a data processing apparatus that employs a filtering method according to aspects of the present disclosure.

FIG. 4 shows a first example of data flow in a data processing system according to aspects of the present disclosure.

FIG. 5 shows a second example of data flow in a data processing system according to aspects of the present disclosure.

FIG. 6 shows an example of a method for filtering a natural language query according to aspects of the present disclosure.

FIG. 7 shows an example of a method for generating a structured query according to aspects of the present disclosure.

FIG. 8 shows an example of a method for generating an invalidity response according to aspects of the present disclosure.

### DETAILED DESCRIPTION

Organizations collect large amounts of data, and this data is often stored in a database. The data can be retrieved and analyzed by making a query to the database using a query language. However, since some users may not be familiar with the precise structure of the data or the format of the query language, a machine learning model can convert natural language queries into structured queries for the database.

Conventional database management systems (DBMS) can evaluate the validity of structured queries using algorithmic methods. However, sometimes computationally intensive machine learning models are used to convert natural language queries into structured queries, and conventional DBMS's are not capable of evaluating the validity of natural language queries. Evaluating the validity of queries after using the machine learning model to convert the query to a structured form wastes resources used by the machine learning model. That is, the computation resources of the model are used even when the resulting structured queries are invalid.

Furthermore, the validity of natural language queries cannot be evaluated using conventional methods. For example, algorithmic methods that check a query against a limited set of acceptable actions, attributes, and syntax structures will not work when a user submits a natural language query.

For example, a database might include information about a “destinationAccount” that has multiple attributes such as “destinationAccountId”. A structured query selecting the attribute destination AccountId might include: “SELECT destinationAccount destinationAccountId”. A user wishing to access the destinationAccountId could make a natural language command such as “get the account id of this account”, and a machine learning model can generate the valid query based on the structure of the data and the query language even if the precise terms of the structure language and the precise attributes of the database are not used.

However, users can make natural language queries that cannot be converted into a valid structured query. For example, a user might ask “what is the home address of the liaison for the account?” If the database does not include such information, the machine learning model may generate a result that will not successfully retrieve the target information. That is, the output of the machine learning model will be an invalid query if it requests information that is not available or refers to an operation that cannot be performed by the database management system. Other examples of invalid queries include queries that refer to data types that are not stored in the database, attributes that are not applicable to any data type, or operations that are not expressible in the structured language.

Generating an invalid query is computationally expensive because it still requires operation of a machine learning mode such as a large language model, but it will not result in the desired outcome (i.e., data retrieval). Therefore, it is desirable to determine in advance whether the output of the machine learning model will be valid.

Accordingly, embodiments of the present disclosure include systems and methods that filter natural language queries to predict whether a machine learning model will generate a valid query using the natural language query as input. If the output is likely to be valid, the natural language query can be converted into a structured query and data can be retrieved from a database. If the output is predicted to be invalid, an invalidity message is retrieved and the machine learning model is not used to convert the query. This saves the time and resources that would otherwise be used generating an invalid query, resulting in a more efficient DBMS.

In some embodiments, to determine the validity of the natural language query, a machine learning model is used to encode the natural language query, and the encoding is compared to embeddings representing one or more valid encodings. If the distance to the valid embeddings is too great, the natural language query can be filtered out and an invalidity message can be sent to the user.

Conventional DBMS's filter structured queries and do not filter natural language queries. These systems waste computing resources by generating invalid output based on an invalid input natural language query. The use of computationally intensive machine learning models to generate an invalid output based on an unstructured natural language query input wastes even more computational resources. By contrast, embodiments of the present disclosure filter natural language input queries using embedding comparisons to determine whether the natural language input queries are likely to be invalid. If they are invalid, use of a subsequent large language model can be avoided to save computation resources.

### Terminology Examples

A “natural language query” refers to a text string that includes natural language requesting data from a database. “Natural language” refers to any language that occurs naturally in a human community. An example natural language query including a request for data stored in a database is the text string “List all new user cohorts in the last six months.” According to some aspects, a natural language query is “unstructured”, or includes text that is not organized according to a particular structure or format.

An “embedding model” refers to a machine learning model trained to generate an embedding based on an input object. An example embedding model comprises an encoder of a transformer.

An “embedding” refers to a representation of an object (e.g., the natural language query) in a lower-dimensional space such that semantic information about the object is more easily captured and analyzed by a machine learning model. For example, the embedding is a numerical representation of the object in a continuous vector space in which objects that include similar semantic information to each other correspond to vectors that are numerically similar to and thus “closer” to each other, thereby allowing a similarity between different objects corresponding to different embeddings to be readily determined. A “natural language query embedding” refers to an embedding of the natural language query, e.g., a representation of the natural language query in an embedding space. An “embedding space” (or a “vector space”) refers to a set having embeddings (or vectors) as elements, and is characterized by a dimension specifying a number of independent directions in the embedding space.

A “validity” of the natural language query refers to a state of whether the natural language query is valid or invalid. A “valid query embedding” refers to an embedding of a query (e.g., an additional natural language query) that is known to be valid (e.g., known to be usable for generating a structured query that will result in data being accurately retrieved). For example, if a distance between the natural language query embedding and the valid query embedding is less than a threshold distance, the natural language query is termed “valid”, while if a distance between the natural language query embedding and the valid query embedding is greater than the threshold distance, the natural language query is termed “invalid”.

An “invalidity response” refers to a response generated based on a determination that a natural language query is invalid. According to some aspects, an invalidity response includes a text string indicating that the natural language query is invalid. An example invalidity response is “The query you have entered is invalid.”

According to some aspects, a “language generation model” is a machine learning model trained to generate text in response to an input. An example language generation model comprises a large language model. An example large language model comprises one or more neural networks trained to understand and generate human-like text based on large amounts of data. A large language model learns patterns and structures of human language by analyzing input text data.

A “structured query” refers to a text string that includes structured text (e.g., text that is organized according to a particular structure or format). Structured text does not include natural language phrases. An example structured query comprises a database query format. A “database query format” refers to a format for a text string that is usable for retrieving data from a database. An example structured query in a database query format is “SELECT destinationAccount.destinationAccountId, destination Account.destinationAccountName FROM destinationAccount LIMIT 15”.

An example of the present disclosure is used in a data retrieval context. In the example, a user provides a natural language query “List all schemas” to a user interface of the data processing system. In the example, the data processing system filters the natural language query by generating a natural language query embedding of the natural language query and computing a distance between the natural language query embedding and a set of valid query embeddings of a set of valid queries. In the example, the data processing system determines that a distance between the natural language query embedding and at least one of the set of the valid query embeddings is less than a threshold distance, and therefore determines that the natural language query is valid.

In the example, in response to the determination, the data processing system generates a structured query “SELECT schema.schemaID . . . ” based on the natural language query and retrieves data “{schemaID: . . . }” from the database using the structured query. In the example, the data processing system displays the retrieved data to the user via the user interface. Furthermore, according to some aspects, the data processing system generates a natural language response based on the retrieved data (e.g., “A list of all of the schemas includes . . . ”) and provides the natural language response to the user.

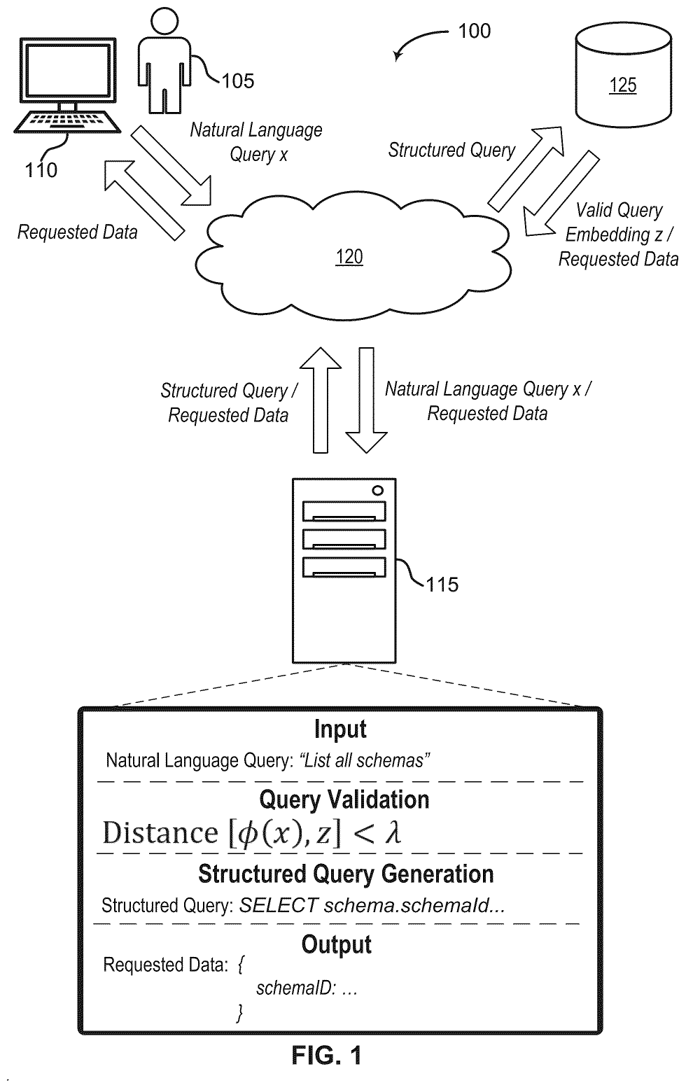

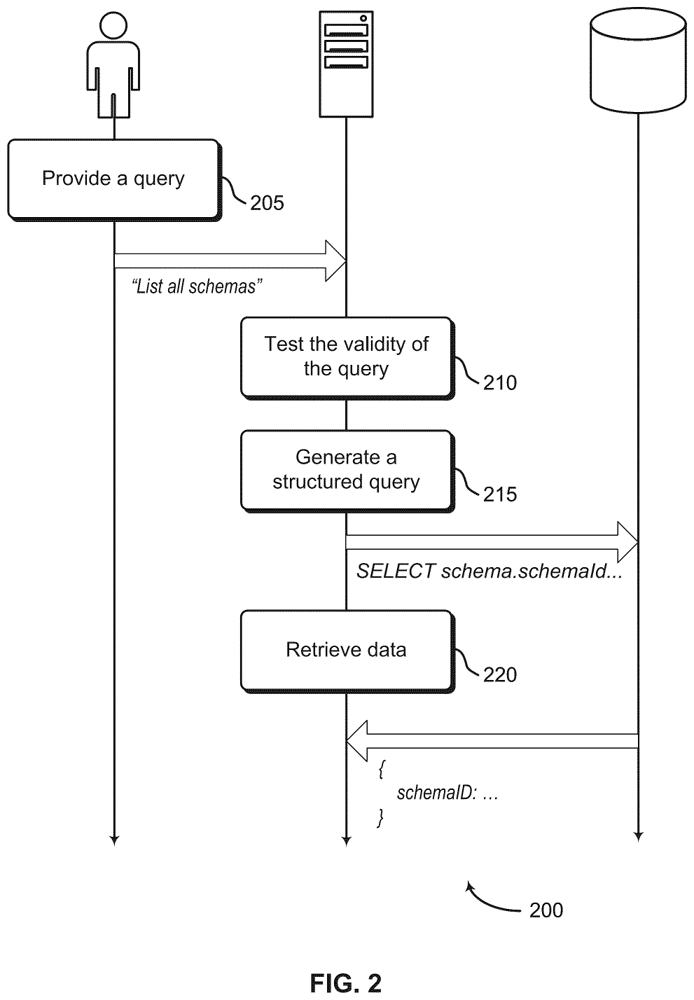

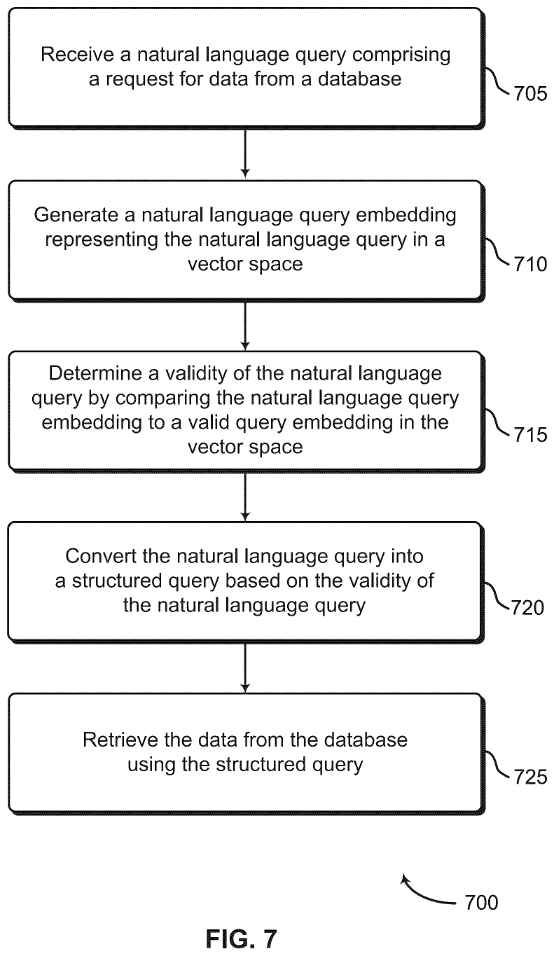

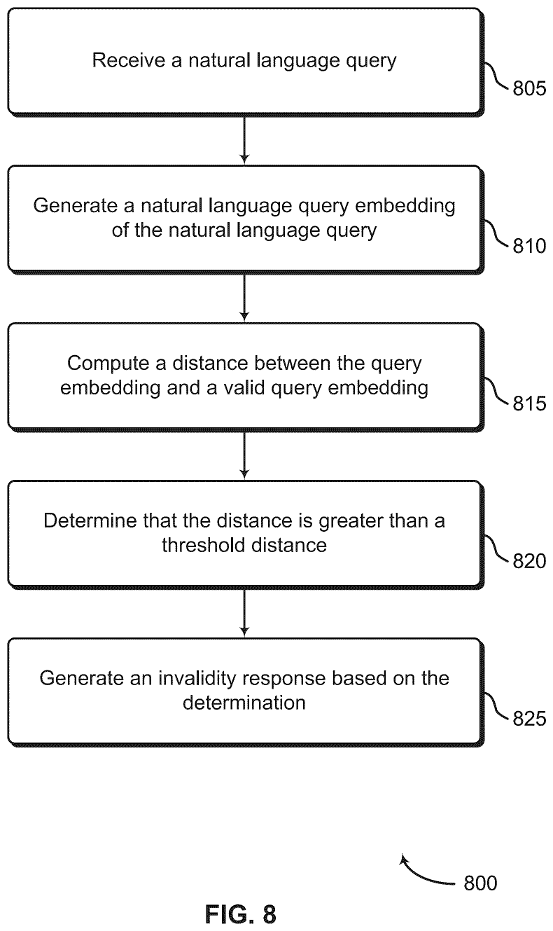

Further example applications of the present disclosure in the data retrieval context are provided with reference to FIGS. 1-2. Details regarding the architecture of the data processing system are provided with reference to FIGS. 1-5. Examples of a process for natural language query filtering are provided with reference to FIGS. 2 and 6-8. Examples of a process for generating a structured query based on a valid natural language query are provided with reference to FIGS. 2 and 7. Examples of a process for generating an invalidity response based on an invalid natural language query are provided with reference to FIG. 8.

### Data Processing System

FIGS. 1-4 show examples of a DBMS system that filters natural language queries. In some embodiments, the DBMS system validates the queries and converts the queries to structured language using a machine learning model. In some embodiments, the DBMS system invalidates the queries and generates an invalidity response.

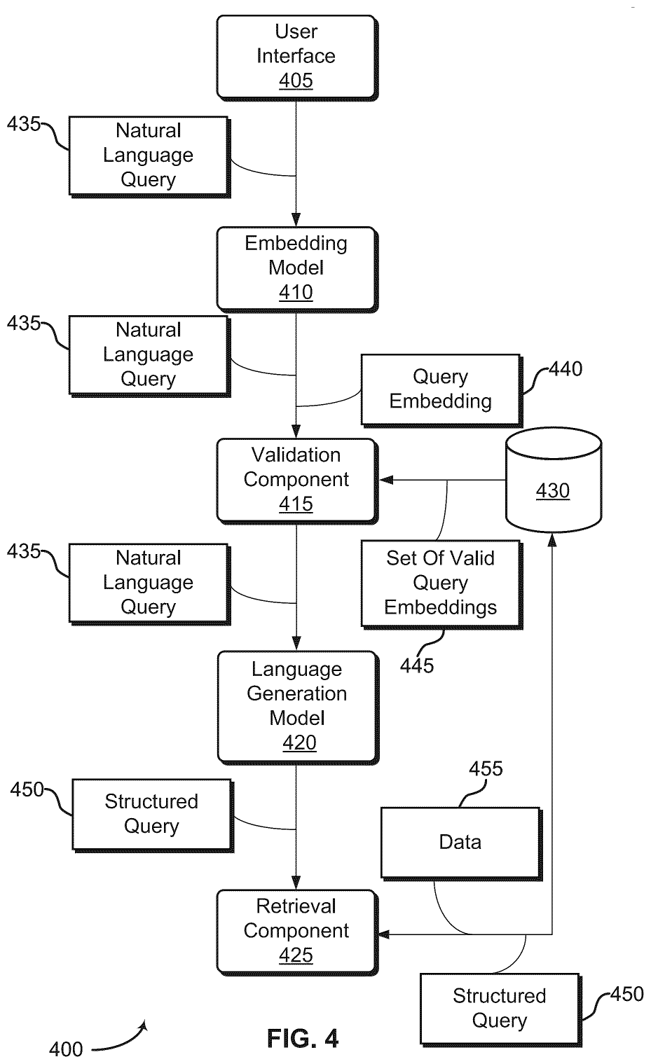

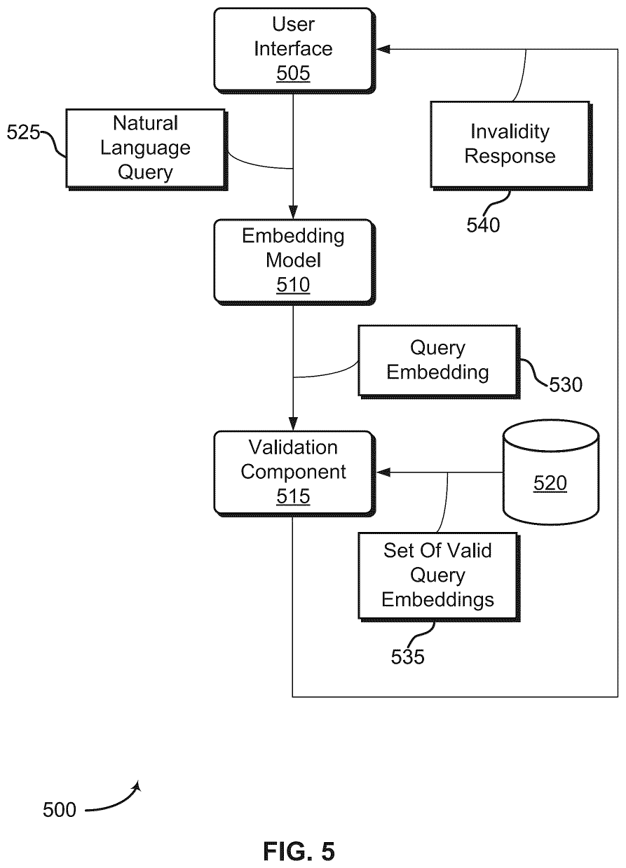

FIG. 1 shows an example of a data processing system 100 according to aspects of the present disclosure. In one aspect, data processing system 100 includes user device 110, data processing apparatus 115, cloud 120, and database 125. Data processing system 100 is an example of, or includes aspects of, the corresponding elements described with reference to FIGS. 4 and 5. According to some aspects, a “computing system” as described herein includes data processing system 100. According to some aspects, a “computing system” as described herein includes data processing apparatus 115.

In the example shown in FIG. 1, user 105 provides a natural language query x requesting data from database 125 to data processing apparatus 115 via a user interface (e.g., a graphical user interface, a text-based interface, or a combination thereof) displayed on user device 110 by data processing apparatus 115. In response, data processing apparatus 115 retrieves a set of valid query embeddings (including valid query embedding z) from database 125. Data processing apparatus 115 validates the natural language query x by generating a natural language query embedding (x) representing the natural language query in a vector space and determining that a distance between the natural language query embedding ø (x) and the valid query embedding z in the vector space is less than a threshold distance A.

In response to validating the natural language query, data processing apparatus 115 converts the natural language query to a structured query. Data processing apparatus 115 retrieves the requested data from database 125 using the structured query and provides the requested data to user 105 via the user interface.

According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface, a text-based interface, or a combination thereof) provided by data processing apparatus 115. In some aspects, the user interface allows information to be communicated between user 105 and data processing apparatus 115.

According to some aspects, a user device user interface enables user 105 to interact with user device 110. In some embodiments, the user device user interface includes an audio device, such as an external speaker system, an external display device such as a display screen, or an input device (e.g., a remote-control device interfaced with the user interface directly or through an I/O controller module). In some embodiments, the user device user interface includes a graphical user interface, a text-based interface, or a combination thereof.

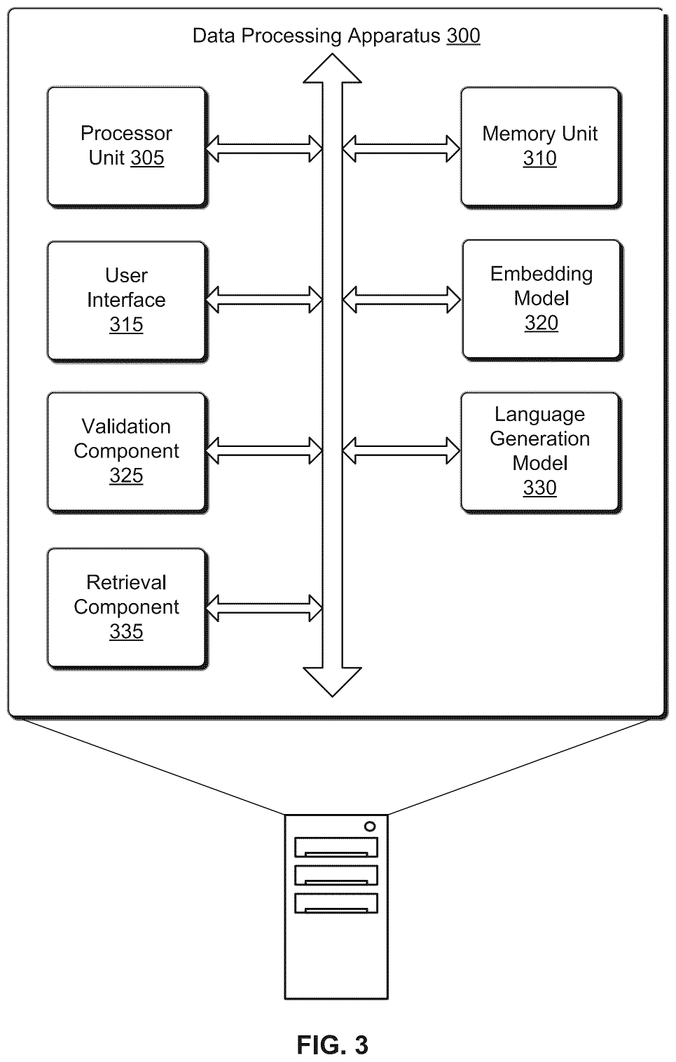

Data processing apparatus 115 is an example of, or includes aspects of, the corresponding element described with reference to FIG. 3. According to some aspects, data processing apparatus 115 includes a computer-implemented network. In some embodiments, the computer-implemented network includes a machine learning model (such as the embedding model and/or the language generation model described with reference to FIG. 3). In some embodiments, data processing apparatus 115 also includes at least one processor, a memory subsystem, a communication interface, an I/O interface, at least one user interface component, and a bus. Additionally, in some embodiments, data processing apparatus 115 communicates with user device 110 and database 125 via cloud 120.

According to some aspects, data processing apparatus 115 is implemented on a server. A server provides at least one function to users linked by way of one or more of various networks, such as cloud 120. In some embodiments, the server includes a single microprocessor board, which includes a microprocessor responsible for controlling all aspects of the server. In some embodiments, the server uses microprocessor and protocols to exchange data with other devices or users on one or more of the networks via at least one protocol, such as hypertext transfer protocol (HTTP), simple mail transfer protocol (SMTP), file transfer protocol (FTP), simple network management protocol (SNMP), and the like.

According to some aspects, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Further detail regarding the architecture of data processing apparatus 115 is provided with reference to FIGS. 2-5. Further detail regarding a process for natural language query filtering are provided with reference to FIGS. 2 and 6-8. Further detail regarding a process for generating a structured query based on a valid natural language query are provided with reference to FIGS. 2 and 7. Further detail regarding a process for generating an invalidity response based on an invalid natural language query are provided with reference to FIG. 8.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet.

Some large cloud networks have functions distributed over multiple locations from central servers. A server is designated an edge server if it has a direct or close connection to a user. In some examples, cloud 120 is limited to a single organization. In other examples, cloud 120 is available to many organizations.

In one example, cloud 120 includes a multi-layer communications network comprising multiple edge routers and core routers. In another example, cloud 120 is based on a local collection of switches in a single physical location. According to some aspects, cloud 120 provides communications between user device 110, data processing apparatus 115, and database 125.

Database 125 is an example of, or includes aspects of, the corresponding element described with reference to FIGS. 4 and 5. According to some aspects, database 125 stores data retrievable based on a structured query.

A database, such as database 125, is an organized collection of data. In an example, database 125 stores data in a specified format known as a schema. According to some aspects, database 125 is structured as a single database, a distributed database, multiple distributed databases, or an emergency backup database. Data storage and processing in database 125 is manageable by a database controller, which can be operated by a user or automatically without interaction from the user. In some examples, database 125 is external to data processing apparatus 115 and communicates with data processing apparatus 115 via cloud 120. In other examples, database 125 is included in data processing apparatus 115.

According to some aspects, database 125 comprises a relational database. A relational database stores information in tabular form, with rows and columns representing different data attributes and various relationships between the data values.

Referring to FIG. 2, an aspect of the present disclosure is used in a data retrieval context. In an example, a user provides a query to a user interface of the data processing system. The data processing system tests the validity of the query using an embedding of the query and an embedding of a query that is known to be valid. The data processing system determines that the query is valid and then converts the query into a structured query. The data processing system uses the structured query to retrieve data from a database and provides the retrieved data to the user.

At operation 205, a user provides a query. In some aspects, the operations of this step refer to, or are performed by, a user as described with reference to FIG. 1. In an example, the user inputs the query (e.g., a natural language query) into an element of a user interface provided on a user device (such as the user device described with reference to FIG. 1) by a data processing apparatus (such as the data processing apparatus described with reference to FIGS. 1 and 3). An example query is “List all schemas”.

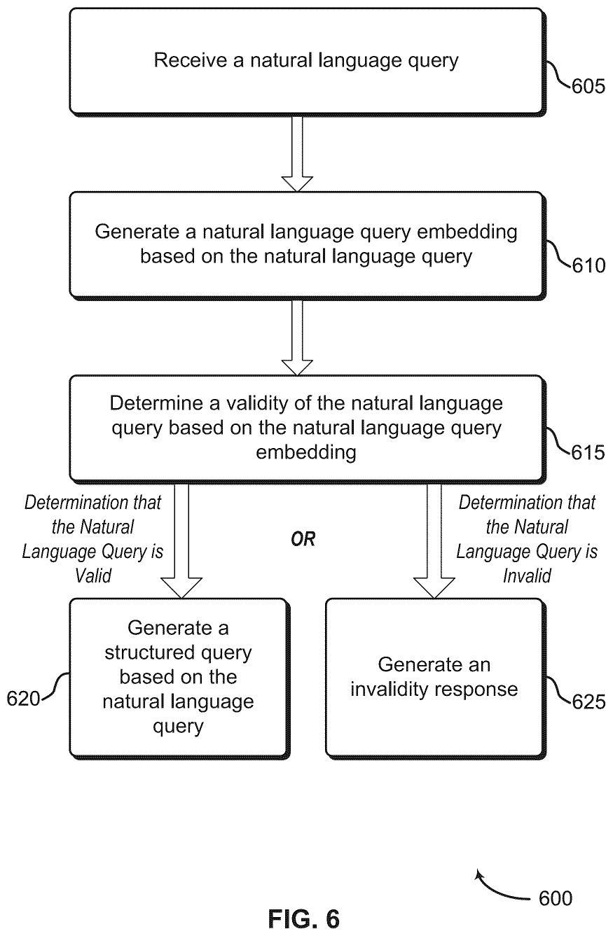

At operation 210, the system tests the validity of the query. In some aspects, the operations of this step refer to, or are performed by, a data processing apparatus as described with reference to FIGS. 1 and 3. For example, the data processing apparatus determines a validity of the query as described with reference to FIGS. 6 and 7.

At operation 215, the system generates a structured query. In some aspects, the operations of this step refer to, or are performed by, a data processing apparatus as described with reference to FIGS. 1 and 3. For example, the data processing apparatus converts the query into the structured query based on the validity of the query as described with reference to FIGS. 6 and 7. An example structured query is “SELECT schema.schemaID . . . ”.

At operation 220, the system retrieves data. In some aspects, the operations of this step refer to, or are performed by, a data processing apparatus as described with reference to FIGS. 1 and 3. For example, the data processing apparatus retrieves the data from a database using the structured query as described with reference to FIG. 7. An example of data retrieved using the structured query is “{schemaID: . . . }”.

FIG. 3 shows an example of a data processing apparatus 300 according to aspects of the present disclosure. Data processing apparatus 300 is an example of, or includes aspects of, the corresponding element described with reference to FIG. 1. In one aspect, data processing apparatus 300 includes processor unit 305, memory unit 310, user interface 315, embedding model 320, validation component 325, language generation model 330, and retrieval component 335. According to some aspects, a “computing system” as described herein includes data processing apparatus 300.

Processor unit 305 includes at least one processor. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some embodiments, processor unit 305 is configured to operate a memory array using a memory controller. In other embodiments, a memory controller is integrated into processor unit 305. In some embodiments, processor unit 305 is configured to execute computer-readable instructions stored in memory unit 310 to perform various functions. In some embodiments, processor unit 305 includes special purpose components for modem processing, baseband processing, digital signal processing, or transmission processing.

Memory unit 310 includes at least one memory device. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 305 to perform various functions described herein.

In some embodiments, memory unit 310 includes a basic input/output system (BIOS) that controls basic hardware or software operations, such as an interaction with peripheral components or devices. In some embodiments, memory unit 310 includes a memory controller that operates memory cells of memory unit 310. In an example, the memory controller includes a row decoder, column decoder, or both. In some embodiments, memory cells within memory unit 310 store information in the form of a logical state.

User interface 315 is an example of, or includes aspects of, the corresponding element described with reference to FIGS. 4 and 5. According to some aspects, user interface 315 is implemented as software stored in memory unit 310 and executable by processor unit 305. According to some aspects, user interface 315 is a graphical user interface, a text-based interface, or a combination thereof. According to some aspects, user interface 315 is displayed on a user device by data processing apparatus 300.

According to some aspects, user interface 315 is configured to receive a natural language query. In some examples, the natural language query includes a request for data from a database. According to some aspects, user interface 315 is configured to display a result based on the structured query. In some examples, user interface 315 receives a modified natural language query following an invalidity response.

Embedding model 320 is an example of, or includes aspects of, the corresponding element described with reference to FIGS. 4 and 5. According to some aspects, embedding model 320 is implemented as software stored in memory unit 310 and executable by processor unit 305, as firmware, as at least one hardware circuit, or as a combination thereof. According to some aspects, embedding model 320 comprises embedding parameters (e.g., machine learning parameters) stored in memory unit 310.

Machine learning parameters, also known as model parameters or weights, are variables that provide a behavior and characteristics of a machine learning model. Machine learning parameters are learned or estimated from training data and are used to make predictions or perform tasks based on learned patterns and relationships in the data.

Machine learning parameters are adjusted during a training process to minimize a loss function or maximize a performance metric. A goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

Artificial neural networks (ANNs) have numerous parameters, including weights and biases associated with each neuron in the network, which control a degree of connections between neurons and influence the ANN's ability to capture complex patterns in data.

An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, the node processes the signal and then transmits the processed signal to other connected nodes.

The signals between nodes comprise real numbers, and the output of each node is computed by a function of the sum of the inputs of each node. Nodes determine the output using other mathematical algorithms, such as selecting the max from the inputs as the output, or any other suitable algorithm for activating the node. Each node and edge are associated with at least one node weight that determines how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to increase the accuracy of the result (e.g., by minimizing a loss which corresponds in some way to the difference between the current result and the target result). The weight of an edge increases or decreases the strength of the signal transmitted between nodes. Nodes have a threshold below which a signal is not transmitted at all. In some examples, the nodes are aggregated into layers. Different layers perform different transformations on their inputs. The initial layer is known as the input layer and the last layer is known as the output layer. In some examples, signals traverse certain layers multiple times.

According to some aspects, embedding model 320 is trained to generate a natural language query embedding representing the natural language query in a vector space. In some examples, generating the natural language query embedding comprises tokenizing the natural language query to obtain a sequence of tokens and computing a vector representing the natural language query based on the sequence of tokens. In some examples, the embedding includes the vector. According to some aspects, embedding model 320 comprises an encoder. According to some aspects, embedding model 320 comprises an encoder of a transformer.

According to some aspects, a transformer comprises one or more ANNs comprising attention mechanisms that enable the transformer to weigh an importance of different words or tokens within a sequence. In some examples, a transformer processes entire sequences simultaneously in parallel, making the transformer highly efficient and allowing the transformer to capture long-range dependencies more effectively.

According to some aspects, a transformer comprises an encoder-decoder structure. The encoder of the transformer processes an input sequence and encodes the input sequence into a set of high-dimensional representations. The decoder of the transformer generates an output sequence based on the encoded representations and previously generated tokens. The encoder and the decoder each include one or more layers of self-attention mechanisms and feed-forward ANNs.

The self-attention mechanism allows the transformer to focus on different parts of an input sequence while computing representations for the input sequence. The self-attention mechanism captures relationships between words of a sequence by assigning attention weights to each word based on a relevance to other words in the sequence, thereby enabling the transformer to model dependencies regardless of a distance between words.

An attention mechanism is a key component in some ANN architectures, particularly ANNs employed in natural language processing (NLP) and sequence-to-sequence tasks, which allows an ANN to focus on different parts of an input sequence when making predictions or generating output.

NLP refers to techniques for using computers to interpret or generate natural language. NLP tasks can involve assigning annotation data such as grammatical information to words or phrases within a natural language expression. Different classes of machine-learning algorithms have been applied to NLP tasks. Some algorithms, such as decision trees, utilize hard if-then rules. Other systems use neural networks or statistical models which make soft, probabilistic decisions based on attaching real-valued weights to input features to express the relative probability of multiple answers.

Some sequence models process an input sequence sequentially, maintaining an internal hidden state that captures information from previous steps. However, this sequential processing can lead to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

According to some aspects, an ANN employing an attention mechanism receives an input sequence and maintains the current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

By incorporating an attention mechanism, an ANN dynamically allocates attention to different parts of the input sequence, allowing the ANN to focus on relevant information and capture dependencies across longer distances.

Validation component 325 is an example of, or includes aspects of, the corresponding element described with reference to FIGS. 4 and 5. According to some aspects, validation component 325 is implemented as software stored in memory unit 310 and executable by processor unit 305, as firmware, as at least one hardware circuit, or as a combination thereof.

According to some aspects, validation component 325 is configured to determine a validity of the natural language query by comparing the natural language query embedding to a valid query embedding in the vector space. In some examples, validation component 325 computes a distance between the natural language query embedding and the valid query embedding. In some examples, validation component 325 computes a distance between the query embedding and each of a set of valid query embeddings. In some examples, validation component 325 identifies a set of valid queries. In some examples, validation component 325 determines the validity constraint based on the set of valid queries.

In some examples, validation component 325 normalizes the natural language query embedding to obtain a normalized embedding. In some examples, the distance is based on the normalized embedding.

In some examples, validation component 325 obtains a set of valid query embeddings. In some examples, validation component 325 compares the natural language query embedding to the set of valid query embeddings to identify a nearest neighbor, where the determination is based on the nearest neighbor. In some examples, validation component 325 determines a validity of a modified natural language query.

In some examples, validation component 325 determines that the distance is less than the threshold distance. In some examples, validation component 325 determines that the distance is greater than a threshold distance. In some examples, validation component 325 generates an invalidity response.

Language generation model 330 is an example of, or includes aspects of, the corresponding element described with reference to FIG. 4. According to some aspects, language generation model 330 is implemented as software stored in memory unit 310 and executable by processor unit 305, as firmware, as at least one hardware circuit, or as a combination thereof. According to some aspects, language generation model 330 comprises text generation parameters (e.g., machine learning parameters) stored in memory unit 310.

According to some aspects, language generation model 330 is trained to convert the natural language query into a structured query based on the validity of the natural language query. In some aspects, the structured query includes a database query format.

According to some aspects, language generation model 330 refrains from converting the natural language query into a structured query. In some examples, language generation model 330 generates a suggested query based on the invalidity response. In some examples, language generation model 330 converts the modified natural language query into a structured query based on the validity of the modified natural language query. In some examples, the structured query includes a database query format.

According to some aspects, language generation model 330 comprises a large language model. In some examples, a large language model comprises one or more ANNs trained to understand and generate human-like text based on large amounts of data. In some examples, by analyzing input text data, a large language model learns patterns and structures of human language. In some examples, the language generation model 330 includes one or more transformers.

Retrieval component 335 is an example of, or includes aspects of, the corresponding element described with reference to FIG. 4. According to some aspects, retrieval component 335 is implemented as software stored in memory unit 310 and executable by processor unit 305, as firmware, as at least one hardware circuit, or as a combination thereof. According to some aspects, retrieval component 335 is configured to retrieve data from a database using the structured query.

FIG. 4 shows a first example of data flow in a data processing system 400 according to aspects of the present disclosure. The example shown includes data processing system 400, natural language query 435, query embedding 440, set of valid query embeddings 445, structured query 450, and data 455.

Data processing system 400 is an example of, or includes aspects of, the corresponding element described with reference to FIGS. 1 and 5. In one aspect, data processing system 400 includes user interface 405, embedding model 410, validation component 415, language generation model 420, retrieval component 425, and database 430.

User interface 405, embedding model 410, and validation component 415 are examples of, or include aspects of, the corresponding elements described with reference to FIGS. 3 and 5. Language generation model 420 and retrieval component 425 are examples of, or include aspects of, the corresponding elements described with reference to FIG. 3. Database 430 is an example of, or includes aspects of, the corresponding element described with reference to FIGS. 1 and 5. Natural language query 435, query embedding 440, and set of valid query embeddings 445 are examples of, or include aspects of, the corresponding elements described with reference to FIG. 5.

Referring to FIG. 4, according to some aspects, a computing system (such as data processing system 400) receives a natural language query including a request for data. The computing system validates the natural language query by determining that a distance between an embedding of the natural language query and a set of valid query embeddings stored in a database is less than a threshold distance. The computing system then converts the validated natural language query into a structured query using a machine learning model and uses the structured query to retrieve the requested data from the database.

In an example, user interface 405 obtains natural language query 435 (e.g., from a user, such as the user described with reference to FIG. 1) and provides natural language query 435 to embedding model 410. Embedding model 410 generates query embedding 440 based on natural language query 435.

Validation component 415 retrieves set of valid query embeddings 445 from database 430. Validation component 415 validates natural language query 435 based on a comparison of query embedding 440 and set of valid query embeddings 445. In response to the validation, validation component 415 provides natural language query 435 to language generation model 420.

Language generation model 420 generates structured query 450 based on natural language query 435 and/or query embedding 440. Language generation model 420 provides structured query 450 to retrieval component 425. Retrieval component retrieves data 455 from database 430 using structured query 450.

FIG. 5 shows a second example of data flow in a data processing system 500 according to aspects of the present disclosure. The example shown includes data processing system 500, natural language query 525, query embedding 530, set of valid query embeddings 535, and invalidity response 540.

Data processing system 500 is an example of, or includes aspects of, the corresponding element described with reference to FIGS. 1 and 4. In one aspect, data processing system 500 includes user interface 505, embedding model 510, validation component 515, and database 520. User interface 505, embedding model 510, and validation component 515 are examples of, or include aspects of, the corresponding elements described with reference to FIGS. 3 and 5. Database 520 is an example of, or includes aspects of, the corresponding element described with reference to FIGS. 1 and 4. Natural language query 525, query embedding 530, and set of valid query embeddings 535 are examples of, or include aspects of, the corresponding elements described with reference to FIG. 4.

Referring to FIG. 5, according to some aspects, a computing system (such as data processing system 500) receives a natural language query including a request for data. The computing system invalidates the natural language query by determining that a distance between an embedding of the natural language query and a set of valid query embeddings stored in a database is greater than a threshold distance. The computing system then generates and displays an invalidity response.

In an example, user interface 505 obtains natural language query 525 (e.g., from a user, such as the user described with reference to FIG. 1) and provides natural language query 525 to embedding model 510. Embedding model 510 generates query embedding 530 based on natural language query 525.

Validation component 515 retrieves set of valid query embeddings 535 from database 520. Validation component 515 determines that natural language query 525 is invalid based on a comparison of query embedding 530 and set of valid query embeddings 535. In response to the determination, validation component 515 generates invalidity response 540. User interface 505 displays invalidity response 540.

Accordingly, one or more aspects of a DBMS system and apparatus include at least one memory component; at least one processor executing instructions stored in the at least one memory; an embedding model comprising embedding parameters stored in the at least one memory component, the embedding model trained to generate a query embedding based on a natural language query; a validation component configured to determine a validity of the natural language query by evaluating the query embedding using a validity constraint based on an embedding of a valid query; and a language generation model comprising text generation parameters stored in the at least one memory component, the language generation model trained to generate a structured query based on the natural language query and the validity of the natural language query.

Some examples of the system and the apparatus further include a database storing data retrievable based on the structured query. Some examples of the system and the apparatus further include a retrieval component configured to retrieve data from a database using the structured query. Some examples of the system and the apparatus further include a user interface configured to receive the natural language query and to display a result based on the structured query.

### Natural Language Query Filtering

FIG. 6 shows an example of a method 600 for natural language query filtering according to aspects of the present disclosure.

Unlike structured queries, the validity of natural language queries cannot be evaluated effectively using conventional methods because the natural language queries may not use the precise terminology of the structured language and the database attributes. However, according to embodiments of the present disclosure, a computing system can evaluate the validity of a natural language query by converting the natural language query into a vector in a semantic vector space and comparing the vector to pre-determined embeddings of valid queries. If the embedding of the natural language query is close to one or more valid embeddings, it is likely that it can be converted into a valid structured query. If not, the natural language query can be filtered out and an invalidity message can be generated to alert the user.

In an example, a user provides a natural language query x. The computing system encodes the natural language query x using an embedding model ϕ(such as the embedding model described with reference to FIGS. 3-5) to obtain a natural language query embedding ϕ(x) (e.g., a high-dimensional vector in a vector space of the natural language query).

The computing system compares the natural language query embedding ϕ(x) and a valid query embedding of a valid query. In some embodiments, if a distance between the two embeddings is less than a threshold distance, the computing system determines that the natural language query is valid. In some embodiments, if a distance between the two embeddings is greater than the threshold distance, the validation component determines that the natural language query is invalid.

By filtering the natural language query based on the query embedding and the validity constraint, the data processing system is able to identify that the natural language query is valid or invalid in a more accurate, efficient, and less resource-intensive manner than attempting to identify and match keywords of the natural language query.

Furthermore, in some embodiments, the computing system includes a language generation model trained to generate a structured query in response to the determination that the natural language query is valid, thereby minimizing a use of computing resources by avoiding a comparative trial-and-error process of generating an invalid structured query based on an invalid natural language query, attempting to perform a downstream task using the invalid structured query (such as retrieving data from a database), failing the downstream task due to use of the invalid structured query, and determining a reason for the failure.

According to some aspects, the set of valid queries (i.e., the queries that a natural language query is compared to in the vector space) comprise natural language text strings that are composed according to criteria having an expectation of validity. In some examples, the set of valid queries include queries generated according to a single entity and a filter condition, where an entity (such as “segment”, “dataset”, or “schema”) is included in a table in the database, and a filter condition is a column of the table including a Boolean condition (such as “isBatch”, “isContinuous”, or “isEnabled”) or a number condition (such as “Time to Live”).

Examples of valid queries corresponding to a single entity and a filter condition include “Can you show me 15 destination accounts?”, “Find all schemas that are not profile enabled”, “List all schemas”, and “Show Identity enabled and Profile-enabled datasets which have Time To Live (TTL) more than 161 days”, which respectively correspond to example structured queries “SELECT destinationAccount.destinationAccountId, destinationAccount.destinationAccountName FROM destinationAccount LIMIT 15,” “SELECT schema.schemaId, schema.schemaName FROM schema WHERE schema.isEnabledForUnifiedProfile=0,” “SELECT schema.schemaId, schema.schemaName FROM schema,” and “SELECT dataset.datasetId, dataset.datasetName FROM dataset WHERE dataset.datasetTTL>161 AND dataset.isEnabledForUnifiedIdentity=1 AND dataset.isEnabledForUnifiedProfile=1.”

In some examples, the set of valid queries include queries generated by joining two tables of the database to link entities. In an example, a schema table is joined with a table to serve as a basis for an example valid query “What are the 4 schemas used in most datasets?” For example, such valid queries are generated by matching primary keys and foreign keys among tables to create a graph among the entities and then inspecting the joinable tables to create relationships so that a mapping is consistent with phrases. Entities such as “attribute” and “segment” are related by phrases such as “used in”, “belong to”, or “utilized in”; entities such as “attribute” and “dataset” are related by phrases such as “used in”, “belong to”, or “utilized in”; entities such as “segment” and “attribute” are related by phrases such as “use”, “include”, or “contain”; and entities such as “segment” and “destination” are related by phrases such as “forwarded to” or “flow to”.

Examples of valid queries comprising linked entities include “What are the attributes that schema ‘SchemaB’ contain?” and “What are the destinations that segment SegmentB flow to?”, which respectively correspond to example structured queries “SELECT schema.schemald, schema.schemaName FROM schema JOIN schema_attribute ON schema.schemaId=schema_attribute.schemaId JOIN attribute ON schema_attribute.attributeId=attribute.attributeld WHERE {entity2_name_condition}” and “SELECT segment.segmentId, segment.segmentName FROM segment JOIN segment_destination ON segment.segmentId=segment_destination.segmentId JOIN destination ON segment_destination.destinationId=destination.destinationId WHERE {entity2_name_condition}”.

In some examples, the database includes one or more datetime columns, such as creation and update times for data included in a table of the database. In some examples, the set of valid queries include queries that use a datetime as a filter condition. For example, such queries are generated by profiling tables of the database that include a datetime column and generating language for a random time range such as “7 days ago”, “last 3 months”, etc., or generating a time-ordered clause such as “most recent”, etc., and inserting the generated language into an entity query template. Examples queries that use a datetime as a filter condition include “Show the most recent datasets updates” and “What audiences that are not streaming have not been updated in over 2 weeks?”, which respectively correspond to example structured queries “SELECT dataset.datasetId, dataset.datasetName, dataset.updatedTime FROM dataset ORDER BY dataset.updatedTime DESC LIMIT 5” and “SELECT segment.segmentId, segment.segmentName FROM segment WHERE segment.isStreaming=0 AND segment.updatedTime<=DATEADD (week, −2, CURRENT_TIMESTAMP)”.

In some examples, the set of valid queries include queries that focus on a particular column of a table of the database. For example, an example query focuses on a “segment” of a table and an “evaluation type” (e.g., an attribute) of the “segment”. For example, such queries are generated by profiling string and Boolean column names from the tables in the database and associating the column names with the table names. Examples of queries that focus on a particular column of a table of the database include “What are the evaluation types of segments?” and “Can you provide the various unique merge policies in audiences which have TTL at most 9 days?”, which correspond to example structured queries “SELECT DISTINCT (segment.isBatch, segment.isEdge, segment.isStreaming) FROM segment” and “SELECT DISTINCT segment.mergePolity FROM segment WHERE segment.segmentTTL<=9”.

In some examples, the set of valid queries comprise a filter condition and entities that are linked by joining two tables. For example, such valid queries are generated by intersecting tables of the database that include columns having filter conditions and table pairs that build relationships with each other. Examples of such valid queries include “How many segments have no corresponding schemas which are profile enabled?” and “What are the segments which are not duplicated flow to destination ‘DestinationC’?”, which respectively correspond to example structured queries “SELECT COUNT(DISTINCT(segment.segmentId)) FROM segment LEFT JOIN segment_schema ON segment.segmentId segment_schema.segmentId JOIN schema ON segment_schema.schemald=schema.schemald WHERE schema.schemald IS NULL AND schema.isEnabledForUnifiedProfile=and 1” “SELECT segment.segmentId, segment.segmentName FROM segment JOIN segment_destination ON segment.segmentId=segment_destination.segmentId JOIN destination ON segment_destination.destinationId=destination.destinationId WHERE destination.destinationName LIKE % DestinationC % AND segment.isDuplicated=0”.

According to some aspects, the set of valid queries are generated by converting a set of valid structured queries into natural language using the language generation model. According to some aspects, the set of valid queries comprising natural language queries are tested by converting the set of valid queries into a respective set of structured queries and using the set of structured queries to retrieve data from the database.

In some examples, the embedding model generates the set of valid query embeddings (including a valid query embedding z) based on a set of valid queries, respectively. The embedding model stores the set of valid query embeddings in the database. The validation component retrieves the valid query embedding z or the set of valid query embeddings from the database.

In some examples, a validation component of the computing system normalizes the natural language query embedding ϕ(x) according to

$$\frac{ϕ ( x )}{{‖ ϕ ( x ) ‖}_{2}}$$

to obtain a normalized query embedding. According to some aspects, the validation component computes a distance between the natural language query embedding ϕ(x) (or the normalized query embedding) and one or more of the set of valid query embeddings in an embedding space (e.g., a vector space) shared by the natural language query embedding ϕ(x) and the set of valid query embeddings (and, in some examples, the normalized query embedding). Examples of techniques for computing the distance include cosine similarity, Euclidean distance, and dot product, although any technique for computing a distance can be used. In an example, the valid query embedding z is a valid query embedding that is least distant from the natural language query embedding ϕ(x) (or the normalized query embedding) in the embedding space.

According to some aspects, the validation component tests the validity of the natural language query by comparing the distance to a threshold distance A. For example, if a distance between the natural language query embedding ϕ(x) (or the normalized query embedding) and a nearest valid query embedding z of the set of valid query embeddings is less than the threshold distance λ, then the validation component determines that the natural language query is valid, while if the distance between the natural language query embedding ϕ(x) (or the normalized query embedding) and the nearest valid query embedding z of the set of valid query embeddings is greater than the threshold distance 1, then the validation component determines that the natural language query is invalid.

In some examples, the validation component determines the threshold distance A to comprise a 95% quantile of nearest-neighbor distances of the set of valid query embeddings (e.g., from each other). In some examples, in response to the determination that the natural language query is valid, the language generation model converts the natural language query to a structured query as described with reference to FIG. 7. Alternatively, in response to the determination that the natural language query is invalid, the validation component generates an invalidity response as described with reference to FIG. 8.

At operation 605, the system receives a natural language query. In some aspects, the operations of this step refer to, or are performed by, a data processing apparatus as described with reference to FIGS. 1 and 3. In an example, the user inputs the natural language query x into an element of a user interface provided on a user device (such as the user device described with reference to FIG. 1) by a data processing apparatus (such as the data processing apparatus described with reference to FIGS. 1 and 3). An example natural language query is “List all schemas”.

At operation 610, the system generates a natural language query embedding based on the natural language query. In some aspects, the operations of this step refer to, or are performed by, an embedding model as described with reference to FIGS. 3-5. In some examples, generating the natural language query embedding includes tokenizing the natural language query to obtain a sequence of tokens and computing a vector representing the natural language query based on the sequence of tokens. In some examples, the embedding includes the vector.

Tokenization refers to a process for converting a text string input into a sequence of token representations of a word, sub-word, or character. In some examples, tokenizing the natural language query includes cleaning the natural language query by removing any characters, punctuation, or special symbols that do not contribute to the meaning of the natural language query, splitting the natural language query into individual tokens representing words, sub-words, or characters of the natural language query, and adding start-of-sequence and end-of-sequence special tokens to denote the beginning and the end of the token sequence, respectively. Tokenization can include adding padding tokens to the token sequence, or truncating the token sequence, where an attention mask is generated to indicate which tokens are actual words and which ones are padding tokens. Each token in the token sequence is converted to a unique integer identifier based on the embedding model's vocabulary. Finally, the token sequence including the unique integer identifiers is converted by the embedding model into the natural language query embedding in the vector space.

At operation 615, the system determines a validity of the natural language query based on the natural language query embedding. In some aspects, the operations of this step refer to, or are performed by, a validation component as described with reference to FIGS. 3-5.

At operation 620, in response to a determination that the natural language query is valid, the system generates a structured query based on the natural language query. In some aspects, the operations of this step refer to, or are performed by, a language generation model as described with reference to FIGS. 3 and 4. For example, in some embodiments, the language generation model converts the natural language query to the structured query as described with reference to FIG. 7.

Alternatively, at operation 625, in response to a determination that the natural language query is invalid, the system generates an invalidity response. In some aspects, the operations of this step refer to, or are performed by, a validation component as described with reference to FIGS. 3-5. For example, in some embodiments, the validation component generates the invalidity response as described with reference to FIG. 8.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some aspects, the operations described herein are composed of various substeps, or are performed in conjunction with other operations.

### Structured Query Generation

FIG. 7 shows an example of a method 700 for generating a structured query according to aspects of the present disclosure.

Referring to FIG. 7, according to some aspects, a data processing system (such as the data processing system described with reference to FIGS. 1 and 4-5) converts a natural language query into a structured query after determining that the natural language query is valid and that conversion is therefore appropriate. In some embodiments, the data processing system validates the natural language query as described with reference to FIG. 6 by determining that a distance between the natural language query and a known valid query in a vector space is less than a threshold distance. Validating the natural language query allows the data processing system to avoid wasting computing resources that would otherwise be used to convert an invalid natural language query into an invalid structured query that would not be useful for effectively retrieving data from a database.

At operation 705, the system receives a natural language query comprising a request for data from a database. In some aspects, the operations of this step refer to, or are performed by, a user interface as described with reference to FIGS. 3-5.

At operation 710, the system generates a natural language query embedding representing the natural language query in a vector space. In some aspects, the operations of this step refer to, or are performed by, an embedding model as described with reference to FIGS. 3-5.

At operation 715, the system determines a validity of the natural language query by comparing the natural language query embedding to a valid query embedding in the vector space. In some aspects, the operations of this step refer to, or are performed by, a validation component as described with reference to FIGS. 3-5.

At operation 720, the system converts the natural language query into a structured query based on the validity of the natural language query. In some aspects, the operations of this step refer to, or are performed by, a language generation model as described with reference to FIGS. 3 and 4.

For example, in response to determining that the natural language query is valid, the validation component prompts the language generation model to generate the structured query based on the natural language query. In some embodiments, the language generation model generates the structured query by decoding the query embedding using a decoder of a transformer. In some embodiments, the language generation model generates the structured query using the natural language query as input. An example structured query is “SELECT schema.schemaID . . . ”.

According to some aspects, in response to determining that the natural language query is valid, the validation component retrieves one or more of a structured query schema, one or more example natural language queries, and one or more example structured queries respectively corresponding to the one or more example natural language queries from the database. In some embodiments, the validation component identifies one or more embeddings of the one or more example natural language queries and retrieves the one or more example natural language queries based on a similarity between the one or more embeddings of the one or more example natural language queries and the query embedding. In some embodiments, the validation component generates a prompt including the structured query schema, the one or more example natural language queries, the one or more example structured queries respectively corresponding to the one or more example natural language queries, and the natural language query. In some embodiments, the language generation model generates the structured query based on the prompt.

According to some aspects, the structured query comprises a database query format. In an example, the structured query is formatted according to a programming language for storing, processing, and retrieving information in/from a relational database.

At operation 725, the system retrieves the data from the database using the structured query. In some aspects, the operations of this step refer to, or are performed by, a retrieval component as described with reference to FIGS. 3 and 4. According to some aspects, the user interface displays the retrieved data. An example of retrieved data is “{schemaID: . . . }”.

In an example, the retrieval component comprises a parser that tokenizes, or replaces, some of the words in the structured query with special symbols. The parser checks the structured query for correctness by verifying that the structured query conforms to semantics of the database query format. The parser returns an error when the parser cannot verify the structured query. In some embodiments, in response to the parser returning an error, the language generation model regenerates the structured query. The parser can validate that the user is authorized to access the database. According to some aspects, the retrieval component comprises a database engine that processes byte code and runs the structured query to retrieve the data from the database according to the structured query.

In some embodiments, the retrieval component provides the data, the natural language query, and the structured query to the language generation model. In some embodiments, the language generation model generates a natural language response based on the data, the natural language query, and the structured query. An example of a natural language response is “A list of all the schemas includes . . . ”. In some embodiments, the retrieval component applies a database template to the natural language response. In some embodiments, the user interface displays the natural language response.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some aspects, the operations described herein are composed of various substeps, or are performed in conjunction with other operations.

Accordingly, one or more aspects of a method for database management include receiving, by a computing system, a natural language query comprising a request for data from a database; generating, using an embedding model of the computing system, a natural language query embedding representing the natural language query in a vector space; determining, by the computing system, a validity of the natural language query by comparing the natural language query embedding to valid query embedding in the vector space; converting, using a language generation model of the computing system, the natural language query into a structured query based on the validity of the natural language query; and retrieving the data from the database using the structured query. In some aspects, the structured query comprises a database query format.

In some examples, generating the natural language query embedding comprises tokenizing the natural language query to obtain a sequence of tokens and computing a vector representing the natural language query based on the sequence of tokens. In some examples, the embedding includes the vector.

In some examples, determining the validity of the natural language query includes computing a distance between the natural language query embedding and the valid query embedding. In some examples, determining the validity of the natural language query includes determining that the distance is less than the threshold distance. Some examples of the method further include identifying a plurality of valid queries. Some examples further include determining the threshold distance based on the plurality of valid queries.

Some examples of the method further include normalizing the natural language query embedding to obtain a normalized embedding. In some aspects, the distance is based on the normalized embedding. Some examples of the method further include computing a distance between the natural language query embedding and each of a plurality of valid query embeddings.

### Invalidity Response Generation

FIG. 8 shows an example of a method 800 for generating an invalidity response according to aspects of the present disclosure.

Referring to FIG. 8, according to some aspects, a data processing system (such as the data processing system described with reference to FIGS. 1 and 4-5) determines that a natural language query for data from a database is invalid (e.g., is not capable of being used as a basis for a structured query that is usable for retrieving the data). In response to the determination, the data processing system generates an invalidity response. Accordingly, the data processing system minimizes a use of computing resources by avoiding a trial-and-error data retrieval process of generating an invalid structured query based on an invalid natural language query, attempting to retrieve data from the database using the invalid structured query, and either failing to retrieve the data or retrieving incorrect data.

At operation 805, the system receives a natural language query. In some aspects, the operations of this step refer to, or are performed by, a user interface as described with reference to FIGS. 3-5.

At operation 810, the system generates, using an embedding model, a query embedding based on the natural language query. In some aspects, the operations of this step refer to, or are performed by, an embedding model as described with reference to FIGS. 3-5.

At operation 815, the system computes a distance between the query embedding and a valid query embedding. In some aspects, the operations of this step refer to, or are performed by, a validation component as described with reference to FIGS. 3-5.

At operation 820, the system determines that the distance is greater than a threshold distance. In some aspects, the operations of this step refer to, or are performed by, a validation component as described with reference to FIGS. 3-5.

At operation 825, the system generates an invalidity response based on the determination. In some aspects, the operations of this step refer to, or are performed by, a validation component as described with reference to FIGS. 3-5.

According to some aspects, the invalidity response includes a text string indicating that the natural language query is invalid. An example invalidity response is “The query you have entered is invalid.” In some embodiments, the user interface displays the invalidity response.

According to some aspects, the language generation model refrains from generating a structured query based on the natural language query in response to the determination. In an example, in response to the determination, the validation component does not instruct the language generation model to generate the structured query.

In an example, the validation component provides the natural language query to the language generation model. The language generation model generates a suggested query comprising natural language based on the invalidity response and the natural language query. The user interface displays the suggested query.

According to some aspects, the user interface receives a modified natural language query following the invalidity response. For example, the user provides the modified natural language query to the user interface. In some embodiments, the validation component determines a validity of the modified natural language query based on a validity constraint as described with reference to FIG. 7.

According to some aspects, the language generation model converts the modified natural language query into a structured query based on the validity of the modified natural language query as described with reference to FIG. 7 (for example, using the modified natural language query as input, or using a prompt as input, where the prompt includes the modified natural language query, a structured query schema, one or more example natural language queries, and one or more example structured queries respectively corresponding to the one or more example natural language queries). In some embodiments, a retrieval component (such as the retrieval component described with reference to FIGS. 3 and 4) retrieves data from the database using the structured query as described with reference to FIG. 7.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some aspects, the operations described herein are composed of various substeps, or are performed in conjunction with other operations.

Accordingly, a method for data processing is described including receiving, by a computing system, a natural language query; generating, using an embedding model of the computing system, a query embedding of the natural language query; computing, by the computing system, a distance between the natural language query embedding and a valid query embedding; determining, by the computing system, that the distance is greater than a threshold distance; and generating, by the computing system, an invalidity response based on the determination.

Some examples of the method further include refraining from generating a structured query based on the natural language query in response to the determination. Some examples of the method further include generating, using a language generation model of the computing system, a suggested query based on the invalidity response.

Some examples of the method further include obtaining a plurality of valid query embeddings. Some examples further include comparing the natural language query embedding to the plurality of valid query embeddings to identify a nearest neighbor. In some aspects, the determination is based on the nearest neighbor.

Some examples of the method further include receiving a modified natural language query following the invalidity response. Some examples of the method further include determining a validity of the modified natural language query. Some examples further include converting, using a language generation model of the computing system, the modified natural language query into a structured query based on the validity of the modified natural language query. Some examples of the method further include retrieving data from a database using the structured query. In some aspects, the structured query comprises a database query format.

The description and drawings described herein represent example configurations and do not represent all the implementations within the scope of the claims. For example, the operations and steps may be rearranged, combined or otherwise modified. Also, in some embodiments, structures and devices are represented in the form of block diagrams to represent the relationship between components and avoid obscuring the described concepts. In some embodiments, similar components or features have the same name but have different reference numbers corresponding to different figures.

Some modifications to the disclosure may be readily apparent to those skilled in the art, and the principles defined herein are applicable to other variations without departing from the scope of the disclosure. Thus, the disclosure is not limited to the examples and designs described herein, but is to be accorded the broadest scope consistent with the principles and novel features disclosed herein.

According to some aspects, the functions described herein are implemented in hardware or software and are executed by a processor, firmware, or any combination thereof. In some embodiments, if implemented in software executed by a processor, the functions are stored in the form of instructions or code on a computer-readable medium.

Computer-readable media includes both non-transitory computer storage media and communication media including any medium that facilitates transfer of code or data. In some embodiments, a non-transitory storage medium is any available medium that is accessible by a computer. Also, in some embodiments, connecting components are properly termed computer-readable media. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” can be based on both condition A and condition B. In other words, the phrase “based on” shall be construed to mean “based at least in part on.” Also, the words “a” or “an” indicate “at least one.”

1. A method for data processing, comprising:
receiving, by a database management system, a natural language query comprising a request for data from a database;
generating, using an embedding model of the database management system, a natural language query embedding representing the natural language query in a vector space;
determining, by the database management system, a validity of the natural language query by based on the natural language query embedding and a plurality of valid query embeddings in the vector space, wherein the plurality of valid query embeddings are known to be useable for generating structured queries that result in data being accurately retrieved from the database;
converting, using a language generation model of the database management system, the natural language query into a structured query based on the validity of the natural language query; and
retrieving the data from the database using the structured query.

2. The method of claim 1, wherein generating the natural language query embedding comprises:
tokenizing the natural language query to obtain a sequence of tokens; and
computing, using the embedding model, a vector representing the natural language query based on the sequence of tokens, wherein the natural language query embedding comprises the vector.

3. The method of claim 1, wherein:
the structured query comprises a database query format.

4. The method of claim 1, wherein determining the validity of the natural language query comprises:
computing a distance between the natural language query embedding and the plurality of valid query embeddings.

5. The method of claim 4, wherein determining the validity of the natural language query comprises:
determining that the distance is less than a threshold distance.

6. The method of claim 5, further comprising:
determining the threshold distance based on the plurality of valid query embeddings.

7. The method of claim 4, further comprising:
normalizing the natural language query embedding to obtain a normalized embedding, wherein the distance is computed based on the normalized embedding.

8. The method of claim 4, further comprising:
computing a distance between the natural language query embedding and each of a plurality of valid query embeddings.

9. A method for data processing, comprising:
receiving, by a database management system, a natural language query comprising a request for data from the database;
generating, using an embedding model of the database management system, a natural language query embedding of the natural language query;
computing, by the database management system, a distance between the natural language query embedding and a plurality of valid query embeddings, wherein the plurality of valid query embeddings are known to be useable for generating structured queries that result in data being accurately retrieved from the database;
determining, by the database management system, that the distance is greater than a threshold distance; and
generating, by the database management system, an invalidity response based on the determination.

10. The method of claim 9, further comprising:
refraining from generating a structured query based on the natural language query in response to the determination.

11. The method of claim 9, further comprising:
generating, using a language generation model of the database management system, a suggested query based on the invalidity response.

12. The method of claim 9, further comprising:
comparing the natural language query embedding to the plurality of valid query embeddings to identify a nearest neighbor, wherein the determination is based on the nearest neighbor.

13. The method of claim 9, further comprising:
receiving a modified natural language query following the invalidity response.

14. The method of claim 13, further comprising:
determining a validity of the modified natural language query; and
converting, using a language generation model of the database management system, the modified natural language query into a structured query based on the validity of the modified natural language query.

15. The method of claim 14, further comprising:
retrieving data from a database using the structured query.

16. The method of claim 14, wherein:
the structured query comprises a database query format.

17. A database management system, comprising:
at least one memory component;
at least one processor executing instructions stored in the at least one memory component;
an embedding model comprising embedding parameters stored in the at least one memory component, the embedding model trained to generate a natural language query embedding of a natural language query comprising a request for data from a database;
a validation component configured to determine a validity of the natural language query by comparing the natural language query embedding to a plurality of valid query embeddings, wherein the plurality of valid query embeddings are known to be useable for generating structured queries that result in data being accurately retrieved from the database; and
a language generation model comprising text generation parameters stored in the at least one memory component, the language generation model trained to convert the natural language query into a structured query based on the validity of the natural language query.

18. The database management system of claim 17, the database management system further comprising:
a database storing data retrievable based on the structured query.

19. The database management system of claim 17, the database management system further comprising:
a retrieval component configured to retrieve data from a database using the structured query.

20. The database management system of claim 17, the database management system further comprising:
a user interface configured to receive the natural language query and to display a result based on the structured query.
